(19) United States
(12) Patent Application Publication
(10) Pub. No.: US 2002/0030491 A1
(43) Pub. Date: Mar. 14, 2002

(54) MRI using multiple RF coils and multiple gradient coils to simultaneously measure multiple samples

(76) Inventor: Katsumi Kose, Chiba (JP)

Correspondence Address: SHLESINGER, ARKWRIGHT & GARVEY LLP, 3000 South Eads Street, Arlington, VA, 22202, US

(21) Appl. No.: 09/903,548

(22) Filed: Jul. 13, 2001

(30) Foreign Application Priority Data
Jul. 31, 2000 (JP) 2000-266247

(51) Int. Cl. G01V 3/00

(52) U.S. Cl. 324/318; 324/309; 324/322

(57) ABSTRACT

Multiple RF coils and multiple gradient coils are used together in a large-volume homogeneous static magnetic field with multiple transmitters and receivers to simultaneously measure MRI images of multiple samples. The RF coils are stored in electromagnetically shielded boxes to remove the electromagnetic coupling among the RF coils. Each gradient coil subsystem is attached to each electromagnetically shielded box to produce intense magnetic field gradients at each sample zone. By using the multiple gradient coils, the electric power to drive the gradient coils can be drastically reduced than that using a single gradient coil system.

### FIELD OF THE INVENTION

This invention generally relates to magnetic resonance imaging (MRI) utilizing nuclear magnetic resonance (NMR) phenomena. It more particularly relates to an MRI or MR microscope system incorporating multiple RF coils, multiple gradient coils, and multiple transmitters and receivers to drastically improve the processing speed.

### BACKGROUND OF THE INVENTION

MRI is by now a commercially available and widely accepted non-invasive method for measuring information about internal structures of living systems and heterogeneous materials. An object to be measured is placed in an intense and homogeneous static magnetic field to polarize the magnetic moments of the atomic nuclei (protons in most cases) contained in the object. As a result, a distribution of a macroscopic nuclear magnetization is produced in the object. By applying a specific radio frequency (RF) pulse, whose frequency is proportional to the magnetic field strength, to the object, the macroscopic nuclear magnetization is turned from the direction of the magnetic field. After the application of the RF pulse, the macroscopic magnetization starts a precession called “Larmor precession” about the static magnetic field. The precessing nuclear magnetization induces a voltage (NMR signal) in a coil surrounding the object or placed near the object.

The precession frequencies are the same in principle for all nuclei in the object in the homogeneous magnetic field and the positions of the nuclei cannot be discriminated. To obtain the spatial information, three kinds of linear magnetic field gradients, Gx, Gy, and Gz, which are the proportionality constants between the magnetic field component along z direction (static magnetic field direction) and x, y, and z coordinates. By applying a gradient field pulse to the precessing nuclear magnetization, the frequency of the nuclear magnetization varies along the gradient field direction, x, y, or z. By applying a set of three gradient pulses sequentially, three-dimensional spatial information is encoded into the frequencies and phases of the Larmor precession. As a result, NMR signal corresponding to a spatial Fourier component of the spatial distribution of the nuclear magnetization is obtained. The spatial distribution of the nuclear magnetization (MRI image) is thus obtained from a data set of the NMR signal through three-dimensional Fourier transform.

Some publications generally relevant to such MRI principles as have just been discussed may be seen as follows:

Lauterbur P. C., Image Formation by Induced Local Interactions:

Examples Employing Nuclear Magnetic Resonance, Nature 1973; 16: 242-243.

Kumar A., Welti D. and Ernst R. R., NMR Fourier Zeugmatography, Journal of Magnetic Resonance, 1975; 18: 69-83.

In conventional MRI systems, the typical spatial resolution of images is about 1 mm. The MRI system for small samples whose spatial resolution is less than 0.1 mm (100 microns) is specifically called as the MR microscope. The MR microscope is often used to image a large number of biological samples. For these applications, the conventional MR microscope design in which a single sample is measured at a time has a severe limitation. To overcome this problem, parallel image acquisition in which multiple samples are imaged at the same time is promising.

### SUMMARY OF THE INVENTION

To acquire MRI images at a high spatial resolution, the signal to noise ratio (SNR) of the NMR signal is the most important factor. Even for a large number of samples to be imaged by an MRI or MR microscope, the RF coils must be optimized for the samples to obtain a good SNR. Thus use of multiple RF coils optimized for multiple samples is the first important part of this invention. In addition, to avoid the interference among the multiple RF coils, each RF coil must be separately stored in an electromagnetically shielded box.

To attain a high spatial resolution, intense and fast-switching magnetic field gradients are required for each sample. Since electric power required for the gradient coil driver is proportional to the 5th power of the linear dimension of the gradient coil, construction of a large bore gradient coil which can accommodate the large number of samples is very difficult. Thus use of multiple gradient coils optimized for multiple samples is another important part of this invention. By using the multiple gradient coils, the electric power required for the gradient coils can be drastically reduced. Since the interference among gradient fields produced by multiple gradient coils cannot be removed by simple electromagnetic shielding, cooperative operations of the multiple gradient coils in MRI data acquisition sequences are essential to simultaneous image acquisitions.

The most important concept of this invention is to use the multiple RF detection coils and multiple gradient coil subsystems attached to RF shield boxes in a large volume homogeneous static magnetic field with multiple NMR transmitters and receivers. The RF excitation and RF signal detection should be multiple to ensure parallel and independent signal detection. However, since the NMR pulse sequence is common to all of the multiple RF and gradient coils, a single pulse programmer for the pulse sequences can be used for all of the multiple units. This design drastically simplifies the MRI system architecture.

### BRIEF DESCRIPTIONS OF THE DRAWINGS

These as well as other objects and advantages of this invention will be more completely understood and appreciated by careful study of the following detailed description of presently preferred exemplary embodiments taken in conjunction with the accompanying drawings of which:

FIG. 1 is a block diagram of an MRI system with multiple RF coils, multiple gradient coils, and multiple transmitters and receivers;

FIG. 2 is a schematic overview of a 4 channel gradient probe used for the MRI shown in FIG. 1;

FIG. 3 schematically depicts the electric current directions for Gz coils of the 4 channel gradient probe shown in FIG. 2;

FIG. 4 schematically depicts the electric current directions of Gx coils of the 4 channel gradient probe shown in FIG. 2;

FIG. 5 schematically depicts the electric current directions of Gz coils of the 8 (4×2) channel gradient probe; and

FIG. 6 schematically depicts the electric current directions of Gx coils of the 8 (4×2) channel gradient probe.

FIG. 7 is a schematic depiction of an MRI sequence for simultaneous acquisition of multiple 3D images.

### DETAILED DESCRIPTION OF THE INVENTION

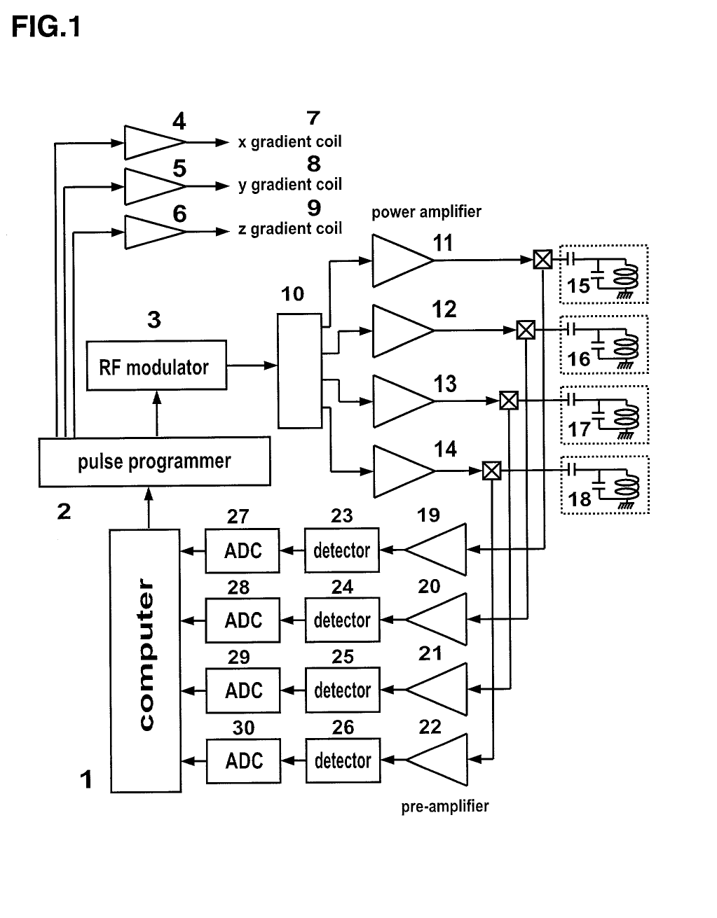

FIG. 1 schematically illustrates an MRI system with 4 channel RF coils and gradient system, and 4 channel excitation and detection system, as an exemplary embodiment of this invention.

In FIG. 1, all of the MRI units are controlled by the computer unit 1. NMR pulse sequences are generated by the pulse programmer 2 which are controlled by the computer unit. RF pulses are generated in the RF modulator 3 according to the pulse sequence timing supplied by the pulse programmer. The RF pulses are supplied to the power divider 10 which supplies RF pulses to RF power amplifiers denoted by 11 to 14. The RF pulses amplified in the power amplifiers are supplied to the RF coils denoted by 15 to 18. The RF coils are stored in electromagnetically shielded boxes and placed in an intense and homogeneous static magnetic field. The RF pulses supplied to the RF coils produce oscillating magnetic fields over the samples inserted in the RF coils and nuclear spins in the samples are exited to produce NMR signals at the resonance frequency.

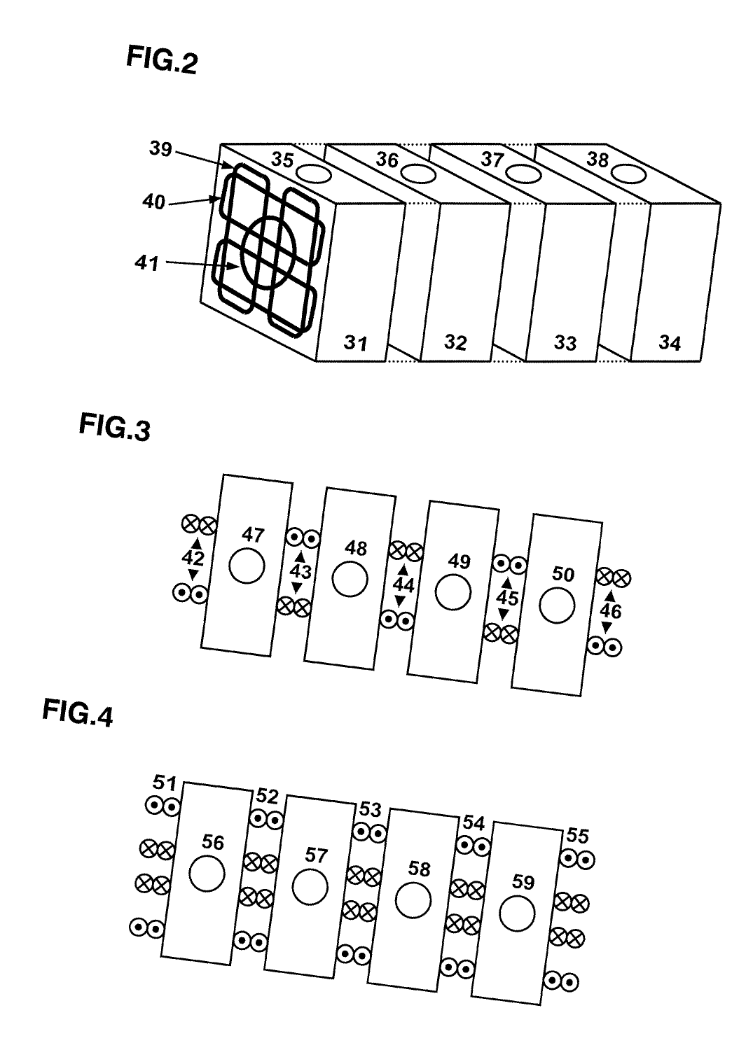

Pulse shapes of the magnetic field gradients are also generated by the pulse programmer 2 and supplied to the gradient drivers 4 to 6. The pulsed electric currents are supplied to gradient coils 7 to 9 (the figures are not shown in FIG. 1 but presented in FIG. 2) by the gradient drivers. The electric current pulses produce magnetic field gradients over the samples placed in the RF coils. The magnetic field gradient pulses modulate the NMR signals of the samples to give spatial information to the NMR signals.

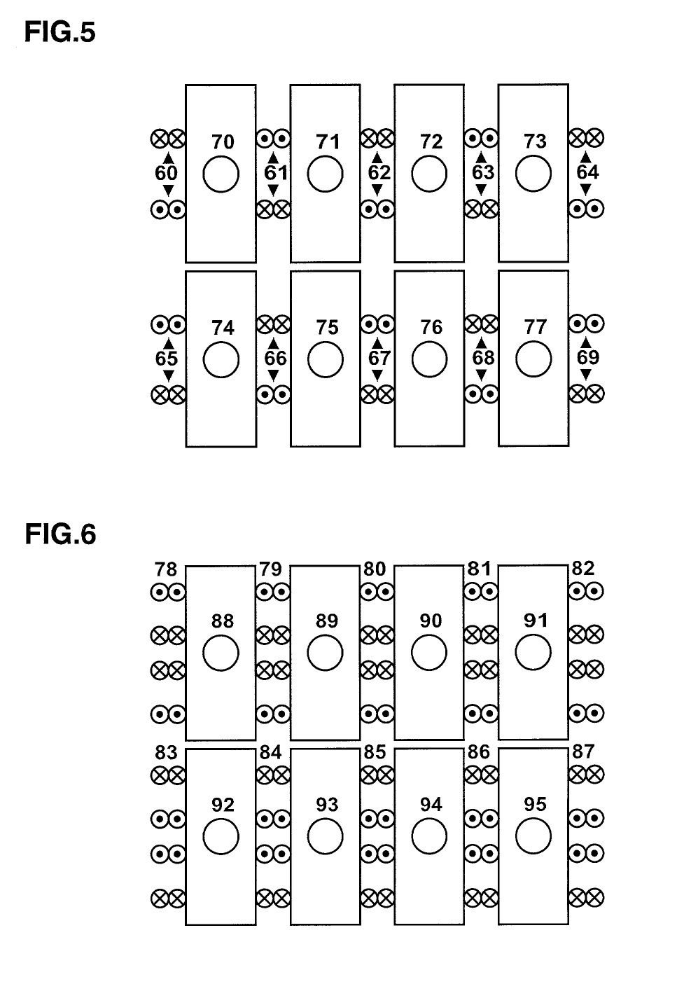

The RF coils are placed in electromagnetically shielded boxes to avoid interference among RF coils and the gradient coils are attached on the surfaces of the shield boxes as will be shown in FIG. 2. The shield boxes must be aligned along straight lines parallel to static magnetic field direction. Exemplary embodiments for the RF probes will be shown in FIG. 2 and FIG. 5.

NMR signals detected at the RF coils denoted by 15 to 18 are amplified by the pre-amplifier denoted by 19 to 22. The amplified NMR signals are supplied to the detectors denoted by 23 to 26. The NMR signals are demodulated by the detectors to generate NMR signals at around audio frequencies. The detected NMR signals are digitally sampled by analog to digital converters denoted by 27 to 30. The sampled data are stored in the computer memory and used for image reconstruction.

As alternative embodiments, the number of channels can be increased to any numbers. The largest number of channels which can be implemented for typical samples (around 1 cm sphere) using an existing whole body MRI magnet (homogeneous magnetic field region is typically a 50 cm diameter sphere) is around 100.

FIG. 2 schematically illustrate a 4 channel gradient probe in which RF coils are placed at the centers of the shield boxes denoted by 31 to 34. The short edges of shield boxes are aligned along the static magnetic field direction (z direction). The dimension of the shield box is 14 cm×14 cm×4 cm and the diameter of the sample holes is changeable but typically 2 cm. Samples to be imaged are put into the sample holes denoted by 35 to 38. Because the magnetic field direction is perpendicular to the axes of sample tubes, solenoid coils are used for the RF coils, which greatly improve the signal to noise ratio of the NMR signals detected by the RF coils.

Gradient coils for x, y, and z directions, one of which are denoted by 39 to 41, are symmetrically attached to the both sides of the shield boxes. The gradient coils for z direction are Maxwell pairs made of circular thin coil elements of which electric currents flow anti-symmetrically about the centers of the sample zones. All of the z gradient coils attached on the surfaces of the shield boxes are connected serially and driven by a single gradient current driver. By this electric connection, all of the z gradient coils are driven at the same time and linear magnetic field gradients are produced over four sample zones as will be shown in more detail in FIG. 3.

One gradient coil set for x or y directions (perpendicular to the static magnetic field direction) consists of four square thin coil elements of which electric currents flow parallel to each other for the nearest portions of the coil elements. All the x or y gradient coils for the 4 channel probe are connected serially and driven each by a single gradient current driver. By this electric connection, all of the x or y gradient coils are driven at the same time and linear magnetic field gradients are produced over four sample zones as will be shown in more detail in FIG. 4.

RF pulses are supplied to the RF coils (15 to 18 in FIG. 1) in the shield boxes via RF connectors (not shown in the figure) attached on the upper side of the boxes. NMR signals are obtained via the same connectors as shown in FIG. 1.

FIG. 3 depicts the horizontal cross section of the 4 channel gradient probe shown in FIG. 2 and schematically illustrates the electric current directions for Gz coils (42 to 46). The Gz coils are Maxwell pairs of which current directions are anti-symmetric about the sample zones denoted by 47 to 50. The current directions shown in the figure cooperatively generate linear magnetic field gradients along z direction over the sample zones. As mentioned above, since all of the coil elements for Gz coils are connected serially, all of the magnetic field gradients are produced at the same time by a single gradient driver. This coil design greatly reduces the electric power for gradient field generation.

FIG. 4 depicts the horizontal cross section of the 4 channel gradient probe shown in FIG. 2 and schematically illustrates the electric current directions for Gx coils (51 to 55). One set of Gx coils consists of four square shaped thin coil elements of which current directions in the portions nearest to the sample zones (56 to 59) are in the same directions. The current directions shown in the figure cooperatively generate linear magnetic field gradients along x direction over the sample zones. As mentioned above, since all of the coil elements for Gx or Gy coils are connected serially, all of the magnetic field gradients are produced at the same time by a single gradient driver.

FIG. 5 shows a different embodiment for a multi-channel gradient probe. Two 4 channel shield box units are aligned along the static magnetic field direction (z direction). In this figure, the horizontal cross section of an 8 (4×2) channel gradient probe and electric current directions for Gz coils (60 to 69) are schematically shown. The Gz coils are Maxwell pairs of which current directions are anti-symmetric about the eight sample zones denoted by 70 to 77. The current directions shown in the figure are determined to cooperatively generate linear magnetic field gradients along z direction over the eight sample zones. Similarly to the 4 channel probe, since all of the coil elements for Gz coils are connected serially, all of the magnetic field gradients in the eight sample zones are produced at the same time by a single gradient driver. This coil design also greatly reduces the electric power for gradient field generation.

FIG. 6 shows the horizontal cross section of an 8 (4×2) channel gradient probe and schematically illustrates the electric current directions for Gx coils (78 to 87). One set of Gx coils consists of four square-shaped coil elements of which current directions in the portions nearest to the sample zones (88 to 95) are in the same directions. The current directions shown in the figure cooperatively generate linear magnetic field gradients along x direction over the sample zones. Since all of the coil elements for Gx coils are connected serially, all of the magnetic field gradients in the eight sample zones are produced at the same time by a single gradient driver.

The number of probes can be increased to any number as far as a homogeneous magnetic field of a magnet can accommodate the probes with the shortest edges of the shield boxes parallel to the static magnetic field. For the allocation of a large number of gradient probes, the linear alignment of gradient probes as shown in FIG. 2 is one fundamental unit and two dimensional probe arrays can be constructed using multiple linear probe units aligned along the magnetic field direction as shown in FIG. 5. Three dimensional probe arrays can be also constructed using multiple linear probe units also aligned along the magnetic field direction.

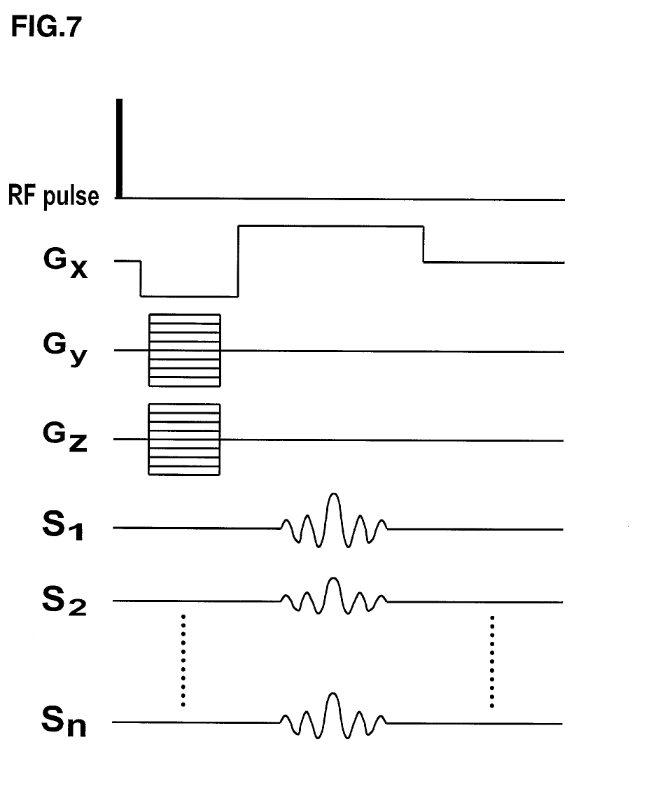

FIG. 7 shows a typical pulse sequence used for simultaneous acquisition of multiple 3D images. The RF pulses are applied to all of the RF coils at the same time and the readout gradient (Gx) and phase encode gradients (Gy and Gz) are applied to the samples at the same timing. However, different NMR signals denoted by S₁ to Sₙ (gradient echo signals) are obtained from the RF coils separately and used for reconstruction of 3D images of different objects.

While only a few specific exemplary embodiments of this invention have been described in detail, those skilled in the art will readily appreciate that many variations and modifications may be made in these exemplary embodiments while yet retaining many of the novel features and advantages of this invention. Accordingly, all such modifications and variations are intended to be included within the scope of the appended claims.

What is claimed is:

1. An improved MRI system having multiple RF coils and multiple gradient coils which are used together in a large-volume homogeneous static magnetic field with multiple receivers to simultaneously measure MRI images of multiple samples.

2. An improved MRI system as in claim 1 wherein said RF coils are placed in electromagnetically shielded boxes to remove the electromagnetic coupling among said RF coils.

3. An improved MRI system as in claim 2 wherein said RF coils are solenoid coils.

4. An improved MRI system as in claim 2 wherein said multiple gradient coil subsystems are attached to both sides of the electromagnetically shielded boxes to produce intense magnetic field gradients over multiple sample zones.

5. An improved MRI system as in claim 4 wherein gradient coils to produce gradient fields changing along the static magnetic field direction are Maxwell pairs or anti-symmetrically current flowing coils and nearest neighbor pairs of the coil elements have the same current directions to efficiently produce gradient fields over said multiple sample zones.

6. An improved MRI system as in claim 5 wherein all of the coil elements for the gradient fields changing along the static magnetic field direction are connected serially and driven by a single gradient driver to drastically simplify the system structure.

7. An improved MRI system as in claim 5 wherein subsets of the coil elements for the gradient fields changing along the static magnetic field direction are connected serially and driven by a single gradient driver and all of the gradient coils are driven multiple gradient drivers to reduce the cost of the gradient drivers and to drastically simplify the system structure.

8. An improved MRI system as in claim 2 wherein gradient coils to produce gradient fields changing perpendicular to the static magnetic field direction consist of four pairs of coil elements whose current directions in portions nearest to samples are in the same directions and nearest neighbor pairs of the coil elements have the same current directions to efficiently produce gradient fields over said multiple sample zones.

9. An improved MRI system as in claim 8 wherein all of the coil elements for the gradient fields changing perpendicular to the static magnetic field direction are connected serially and driven by a single gradient driver to drastically simplify the system structure.

10. An improved MRI system as in claim 8 wherein subsets of the coil elements for the gradient fields changing perpendicular to the static magnetic field direction are connected serially and driven by a single gradient driver and all of the gradient coils are driven multiple gradient drivers to reduce the cost of the gradient drivers and to drastically simplify the system structure.

11. An improved MRI system as in claim 1 wherein a pulse programmer and RF modulator is common to all of the transmitter channels to drastically simplify the system architecture.
